(19) United States
(12) Patent Application Publication
(10) Pub. No.: US 2013/0149227 A1
(43) Pub. Date: Jun. 13, 2013

(54) METHOD OF PREPARING OLIVINE CATHOD MATERIAL FOR LITHIUM SECONDARY BATTERY

(71) Applicant: RESEARCH INSTITUTE OF INDUSTRIAL SCIENCE & TECHNOLOGY, Pohang City (KR)

(72) Inventors: Uong CHON, Pohang-si (KR); Ki Hong Kim, Pohang-si (KR); Jin Gun Sohn, Pohang-si (KR); Chang Ho Song, Incheon (KR); Gi Chun Han, Cheongju-si (KR); Ki Young Kim, Yongin-si (KR)

(73) Assignee: RESEARCH INSTITUTE OF INDUSTRIAL SCIENCE & TECHNOLOGY, Pohang City (KR)

(21) Appl. No.: 13/761,694

(22) Filed: Feb. 7, 2013

Related U.S. Application Data
(63) Continuation of application No. PCT/KR2011/005960, filed on Aug. 12, 2011.

(30) Foreign Application Priority Data
Aug. 12, 2010 (KR) 10-2010-0077948

(51) Int. Cl. C01B 25/45

(52) U.S. Cl. CPC C01B 25/45
USPC 423/306

(57) ABSTRACT

The present invention relates to a method of preparing olivine cathode materials for lithium secondary battery. More specifically, a method of preparing an olivine-based cathode material for secondary battery comprising the steps of: dissolving an iron supplying material, and a lithium phosphate by adding an acid; forming a chelate polymer by adding a chelate agent and a polymerization agent in the solution of the dissolving step followed by heating; pyrolyzing the chelate polymer under reducing atmosphere; and thermally reducing the chelated polymer degraded during the pyrolysis is provided.

### CROSS-REFERENCE TO RELATED APPLICATIONS

This application is a continuation of International Application No. PCT/KR2011/005960, filed on Aug. 12, 2011, which claims priority to Korean Patent Application No. 10-2010-0077948, filed on Aug. 12, 2010, the entire contents of which are incorporated herein by reference.

### TECHNICAL FIELD

The present invention relates to a method of preparing olivine cathode materials for lithium secondary battery.

### BACKGROUND ART

The current trend for weight lightening as well as miniaturization of notebooks, cell phones, and hydrid and electric cars has been the impelling force for the need for active development of lithium secondary battery. Generally, the lithium secondary battery includes a graphite-based anode capable of intercalating and deintercalating lithium, a cathode applied with complex oxides containing lithium, and an organic electrolyte. The cathode material used in the lithium secondary must satisfy the prerequisites such as high energy density, excellent cyclic characteristic during intercalation and deintercalation, and chemical stability against the electrolyte.

Some of widely used cathode materials for the lithium secondary battery include LiCoO₂, LiNiO₂, and LiMnO₂. However, in addition to its high price, LiCoO₂ causes environmental contamination due to its use of cobalt. LiNiO₂, as a cathode material, is also unsatisfactory mainly due to its complicated manufacturing process and low thermostability. Similarly, in case of LiMnO₂, the electrode is susceptible to rapid deterioration at high temperature and has low conductivity. On the contrary, olivine-based cathode materials such as LiFePO₄ have drawn attention as a new alternative material due to its abundant source, inexpensive price, and eco-friendliness. Furthermore, having the discharge voltage of 3.4V (vs. Li/Li+), the olivine-based cathode materials may require lower voltage and electricity compared to the conventional materials, while having a superior battery capacity. Accordingly, a need for an effective method for preparing an olivine-based cathode material has been intensified.

### DISCLOSURE

### Technical Problem

In accordance with one embodiment of the present invention, a method of directly preparing a homogeneous olivine-based cathode material, which does not require a synthetic process of lithium hydroxide or lithium carbonate, may be provided. Such method, suitable for mass production, may allow an economical preparation of a high-quality olivine-based cathode material.

### Technical Solution

In accordance with one embodiment of the present invention, a method of preparing an olivine-based cathode material for secondary battery comprising the steps of: dissolving an iron supplying material, and a lithium phosphate by adding an acid; forming a chelate polymer by adding a chelate agent and a polymerization agent in the solution of the dissolving step followed by heating; pyrolyzing the chelate polymer under reducing atmosphere; and thermally reducing the chelated polymer degraded during the pyrolysis may be provided.

According to one embodiment of the present invention, the step of dissolving an iron supplying material, and a lithium phosphate by adding an acid; may be the step of dissolving an iron supplying material, a lithium phosphate, and a phosphorous bearing material by adding an acid.

According to one embodiment of the present invention, the lithium phosphate may be precipitated by adding a phosphorous supplying material in a lithium bearing solution.

According to one embodiment of the present invention, the iron supplying material may be at least one selected from an electrolytic iron, an oxidized steel and a metal iron salt.

According to one embodiment of the present invention, the chelate agent may be at least one selected from the group consisting of citric acid, adipic acid, methacrylic acid, glycolic acid, oxalic acid, ethylenediaminetetraacetic acid, alkylene-diamine-polyalkanoic acid, hydroxyalkyl alkylene-diamine-polyalkanoic acid, nitrilotriacetic acid, polyphosphoric acids, and a mixture thereof.

According to one embodiment of the present invention, the polymerization agent may be at least one selected from the group consisting of ethylene glycol, divinylbenzene, divinyltoluene, ethyleneglycoldimethacrylate, trimethylpropane triacrylate, diarylmaleate, diarylfumarate, triaryl cyanurate, diarylphthalate, alkylmethacrylate, aryl acrylate and a mixture thereof.

According to one embodiment of the present invention, the pyrolyzing step may be performed at a temperature ranging from 400° C. to 550° C.

According to one embodiment of the present invention, the reducing atmosphere of the pyrolyzing step may be argon atmosphere.

According to one embodiment of the present invention, the thermal reducing step may be performed at a temperature ranging from 700° C. to 1,000° C.

According to one embodiment of the present invention, the reducing atmosphere may be an atmosphere under which a volume ratio of CO to CO2 is 1 to 1.

According to another embodiment of the present invention, the olivine-based cathode material may comprise LiFePO4.

### Advantageous Effects

In accordance with one embodiment of the present invention, the conventional complicated manufacturing process may be simplified by the present method of preparing olivine cathode materials for lithium secondary battery. The method may be suitable for mass production because it allows direct preparation of the olivine cathode materials without requiring a synthetic process of lithium hydroxide or lithium carbonate. Further, the secondary battery prepared according to the present invention may be economical and have superior battery characteristics as the prepared fine particles of the cathode materials may have a large specific surface area.

### DESCRIPTION OF DRAWINGS

FIG. 1 is a flowchart illustrating a method of preparing olivine cathode materials for lithium secondary battery according to one embodiment of the present invention.

FIG. 2 is an image of an optical microscope of the synthesized LiFePO4 cathode material powder according to one embodiment of the present invention.

FIG. 3 is a graph showing X-ray diffraction result of the LiFePO4 cathode material powder according to one embodiment of the present invention.

### MODE FOR INVENTION

The feature of one embodiment of the present invention will be described in more detail with reference to the figures as follows.

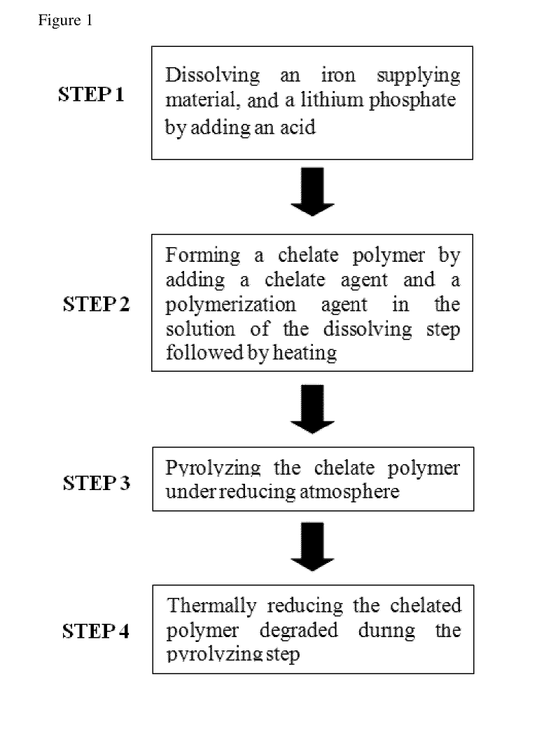

As shown in FIG. 1, in accordance with one embodiment of the present invention, a step of dissolving an iron supplying material, and a lithium phosphate by adding an acid is performed (Step 1). In other words, the iron supplying material, lithium phosphate and phosphorous bearing material may be mixed with acid with a certain molar ratio.

According to one embodiment of the present invention, the step of dissolving an iron supplying material, and a lithium phosphate by adding an acid; may be the step of dissolving an iron supplying material, a lithium phosphate, and a phosphorous bearing material by adding an acid.

The iron supplying material may be, for example, an electrolytic iron or an oxidized steel such as FeO, Fe2O4, Fe2O3 which easily dissolves in acids. In addition to the electrolytic iron, various metal salt compounds such hydrates including FeNO3, FeCl2, FeCl3 prone to easy dissolution in acids may be used. Further, a lithium phosphate powder may be used considering the solubility of the lithium phosphate.

The lithium phosphate powder may be precipitated by adding a phosphorous supplying material in a lithium bearing solution.

The phosphorous supplying material may be at least one selected from the group consisting of phosphorous, phosphoric acid, phosphate, and a mixture thereof.

In order for the lithium phosphate to be precipitated in a solid state without being re-dissolved, the concentration (i.e., the dissolved concentration in the lithium bearing solution) should be 0.39 g/L or greater.

The phosphate may be, for example, but is not limited thereto, potassium phosphate, sodium phosphate, and ammonium phosphate. Specifically, the ammonium may be (NR4)3PO4, wherein R is independently a hydrogen, a heavy hydrogen, a substituted or unsubstituted C1-C10 alkyl group, but not limited thereto.

More specifically, the phosphate may be, for example, but is not limited thereto, mono-potassium phosphate, di-potassium phosphate, tri-potassium phosphate, mono-sodium phosphate, di-sodium phosphate, tri-sodium phosphate, aluminum phosphate, zinc phosphate, poly-ammonium phosphate, sodium-hexa-meta-phosphate, mono-calcium phosphate, di-calcium phosphate, and tri-calcium-phosphate.

The phosphorous supplying material may be water-soluble. In the case the phosphorous supplying material is water-soluble, the reaction with lithium contained in the lithium bearing solution may easily occur.

Further, after the phosphorous supplying material is added, the filtrate is calcinated for 10 to 15 minutes at room temperature, or at a temperature range of 40-200° C., 50-200° C., 60-200° C., 70-200° C., 80-200° C., or 90-200° C.

Although it is advantageous to extend the calcining time and raise the temperature for the purpose of producing lithium phosphate, if the calcining time exceeds 15 minutes or if the calcining temperature exceeds 200° C., the production yield of lithium phosphate may be saturated.

After precipitating lithium phosphate, the step of extracting the precipitated lithium phosphate filtered from the filtrate may be performed. Upon such filtration, the extracted lithium phosphate may be washed to obtain high purity lithium phosphate powder.

Subsequently, a step of forming a chelate polymer by adding a chelate agent and a polymerization agent in the solution of the dissolving step followed by heating may be performed (Step 2).

In other words, the chelate agent is added to the solution to dissolve hydrogen ions for dissolution, and these ions may later bond with the metal ions dissolved by the solution.

The chelate agent may be at least one selected from the group consisting of citric acid, adipic acid, methacrylic acid, glycolic acid, oxalic acid, ethylenediaminetetraacetic acid, alkylene-diamine-polyalkanoic acid, hydroxyalkyl alkylene-diamine-polyalkanoic acid, nitrilotriacetic acid, polyphosphoric acids, and a mixture thereof. More specifically, the chelate agent may be relatively cheap citric acid, which shows excellent chelation reactivity.

After adding a polymerization agent along with the chelate agent, the mixture is heated and subject to esterification to form a chelate polymer.

According to one embodiment of the present invention, the polymerization agent may be at least one selected from the group consisting of ethylene glycol, divinylbenzene, divinyltoluene, ethyleneglycoldimethacrylate, trimethylpropane triacrylate, diarylmaleate, diarylfumarate, triaryl cyanurate, diarylphthalate, alkylmethacrylate, aryl acrylate and a mixture thereof. More specifically, the polymerization agent may be ethylene glycol having superior polymerization reactivity.

The polymerization reaction may be performed at a temperature ranging from 100° C. to 250° C.

When the temperature is lower than 100° C., the polymerization reaction may be relatively inefficient, whereas when the temperature exceeds 250° C., the management of the reaction may be problematic as the efficient removal of the excess heat generated from the polymerization may become difficult.

Subsequent to the step of forming the chelate polymer, an additional step of volatizing a solvent may be performed. The step may be performed at a temperature ranging from 300° C. to 400° C.

Then, the step of pyrolyzing the chelate polymer under reducing atmosphere may be performed (Step 3).

In order to prevent the oxidation of iron(Fe2+), the pyrolysis is performed under reducing atmosphere, and argon gas may be injected for the reducing atmosphere.

The pyrolysis step includes the removing by evaporation of carbon and hydrogen atoms degraded from the heating of the chelate polymer for the preparation of the olivine cathode materials, such as LiFePO4

The pyrolyzing step may be performed at a temperature ranging from 400° C. to 550° C.

At a pyrolyzing temperature lower than 400° C., the degradation process of the chelate polymer may be inefficient, whereas at a temperature greater than 550° C., the effects of pyrolysis may saturate.

After the step of pyrolysis, a step of thermally reducing the chelated polymer degraded during the pyrolyzing step may be performed (Step 4).

The reducing atmosphere may be H2 atmosphere, or CO and CO2 atmosphere, and specifically, may be an atmosphere under which a volume ratio of CO to CO2 is 1:1

When the oxygen partial pressure is further reduced under the atmosphere under which a volume ratio of CO to CO2 is 1:1, the oxidation of iron(Fe2+) may be effectively prevented.

The thermal reducing step may be performed at a temperature ranging from 700° C. to 1,000° C.

If the temperature is lower than 700° C., a crystalline material may be difficult to form as the synthesis of the olivine cathode materials having Fe2+ may become inefficient. On the other hand, if the temperature exceeds 1,000° C., the synthesis may be saturated, causing excessive energy consumption.

The synthesized olivine cathode material powder for lithium secondary battery may be extracted according to the well-known methods in the field.

The olivine-based cathode material, for example, may comprise LiFePO4, but is not limited thereto. Alternatively, other transition metals may be doped in replace of the iron metal.

The present invention is further illustrated by the following examples, although the following examples relate to preferred embodiments and are not to be construed as limiting on the scope of the invention.

### Example 1

The molar ratio of an electrolytic iron, lithium phosphate powder, and phosphoric acid was adjusted to be 1:1:1, respectively, and the mixture was subsequently dissolved in the aqua regia mixed with a hydrochloric acid and nitric acid at a volume ratio of 3:1. Citric acid and ethylene glycol were added to the mixed solution, followed by heating at 130° C. for 2 hours. Upon heating at 200° C. for 2 hours for concentration, a chelate polymer was formed. Subsequently, the solvent is volatized by heating at 350° C. for 1 hour, and the heating temperature of 450° C. is maintained for 1 hour under the argon atmosphere for the pyrolysis of the chelate polymer. The final thermal reduction under the atmosphere of CO and CO2, having the volume ratio of 1:1, at 900° C. was performed for 30 mins to prepare LiFePO4 powder.

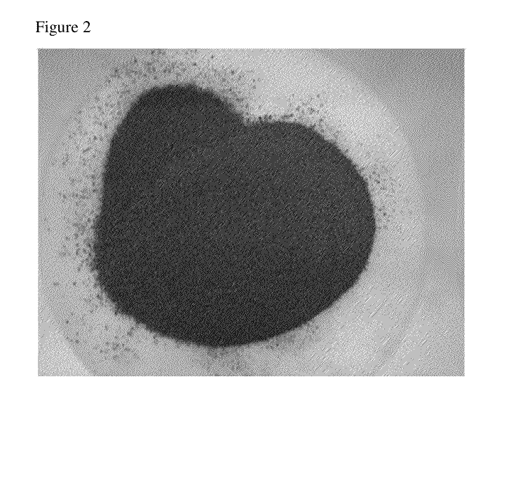

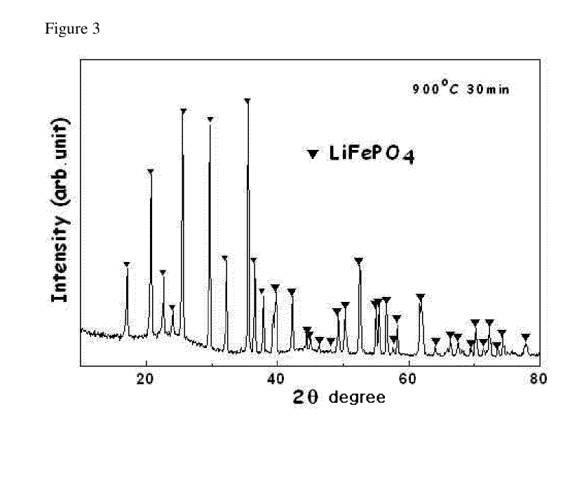

The prepared LiFePO4 powder was analyzed using an optical microscope and X-ray diffractometer(XRD). The results are indicated in FIGS. 2 and 3. As shown in FIG. 2, the synthesized LiFePO4 powder according to the method of the present invention contains fine and homogeneous particles. Further, as can be seen in FIG. 3, it can be confirmed that a mono-morphological cathode material powder without impurity peak was synthesized.

Accordingly, as can be seen in the Example, in accordance with one embodiment of the present invention, the method allows a direct preparation of olivine cathode materials without requiring a synthetic process of lithium hydroxide or lithium carbonate. The method is suitable for mass production and economical. The secondary battery prepared according to the present invention may have superior battery characteristics as the prepared fine particles of the cathode material may have a large specific surface area.

In the foregoing specification, specific embodiments of the present invention have been described. However, one of ordinary skill in the art will appreciate that various modifications and changes can be made without departing from the spirit and scope of the present invention as set forth in the various embodiments discussed above. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements as described herein.

What is claimed is:

1. A method of preparing an olivine-based cathode material for secondary battery comprising the steps of:
dissolving an iron supplying material, and a lithium phosphate by adding an acid;
forming a chelate polymer by adding a chelate agent and a polymerization agent in the solution of the dissolving step followed by heating;
pyrolyzing the chelate polymer under reducing atmosphere; and
thermally reducing the chelated polymer degraded during the pyrolysis.

2. The method according to claim 1, wherein the step of dissolving an iron supplying material, and a lithium phosphate by adding an acid; is the step of dissolving an iron supplying material, a lithium phosphate, and a phosphorous bearing material by adding an acid.

3. The method according to claim 1, wherein the lithium phosphate is precipitated by adding a phosphorous supplying material in a lithium bearing solution.

4. The method according to claim 1, wherein the iron supplying material is at least one selected from an electrolytic iron, an oxidized steel, and a metal iron salt.

5. The method according to claim 1, wherein the chelate agent is at least one selected from the group consisting of citric acid, adipic acid, methacrylic acid, glycolic acid, oxalic acid, ethylenediaminetetraacetic acid, alkylene-diamine-polyalkanoic acid, hydroxyalkyl alkylene-diamine-polyalkanoic acid, nitrilotriacetic acid, polyphosphoric acids, and a mixture thereof.

6. The method according to claim 1, wherein the polymerization agent is at least one selected from the group consisting of ethylene glycol, divinylbenzene, divinyltoluene, ethyleneglycoldimethacrylate, trimethylpropane triacrylate, diarylmaleate, diarylfumarate, triaryl cyanurate, diarylphthalate, alkylmethacrylate, aryl acrylate and a mixture thereof.

7. The method according to claim 1, wherein the pyrolyzing step is performed at a temperature ranging from 400° C. to 550° C.

8. The method according to claim 1, wherein the reducing atmosphere of the pyrolyzing step is argon atmosphere.

9. The method according to claim 1, wherein the thermal reducing step is performed at a temperature ranging from 700° C. to 1,000° C.

10. The method according to claim 1, wherein the reducing atmosphere is an atmosphere under which a volume ratio of CO to CO₂ is 1:1.

11. The method according to claim 1, wherein the olivine-based cathode material comprises LiFePO₄.
